(19) United States
(12) Patent Application Publication
(10) Pub. No.: US 2026/0233703 A1
(43) Pub. Date: Aug. 13, 2026

(54) Method and Device for Providing an Emergency Access to a Motor Vehicle

(71) Applicant: Bayerische Motoren Werke Aktiengesellschaft, Muenchen (DE)

(72) Inventors: Matthias FINK, Muenchen (DE); Thomas NACHBAR, Poing (DE)

(21) Appl. No.: 19/531,880

(22) Filed: Feb. 6, 2026

(30) Foreign Application Priority Data
Feb. 7, 2025 (DE) 10-2025-104 624.7

(51) Int. Cl. B60R 25/24; B60R 25/00; B60R 25/045; B60R 25/30

(52) U.S. Cl. CPC B60R 25/241; B60R 25/007; B60R 25/045; B60R 25/305; B60R 2325/103

(57) ABSTRACT

The invention relates to a device and a method for providing emergency access to a motor vehicle. One form of a method comprises: receiving a generation request at a remote vehicle management device to generate emergency access information for an emergency access to the motor vehicle; providing emergency access information to a user of the motor vehicle; providing the emergency access information by way of the user to the motor vehicle; reading the emergency access information by way of the motor vehicle, and providing an emergency access to the motor vehicle by way of the motor vehicle in response to the reading of the emergency access information.

### CROSS REFERENCE TO RELATED APPLICATION

This application claims priority under 35 U.S.C. §119 from German Patent Application No. DE 10 2025 104 624.7, filed February 7, 2025, the entire disclosure of which is herein expressly incorporated by reference.

### BACKGROUND AND SUMMARY

The present invention relates to a method and a device for providing an emergency access to a vehicle.

A method for controlling a function of a vehicle is specified, for example, in document DE 10 2023 117 258 A1, wherein a digital vehicle key, by which a function of the vehicle is remote-controllable, is stored on a mobile terminal.

It is the objective of the invention to specify an improved method and an improved device for providing an emergency access to a motor vehicle.

This objective is achieved according to forms of the invention by the subjects of the independent claims. Advantageous embodiments and implementations of the invention are the subject matter of the dependent claims and the description.

A method according to forms of the invention for providing an emergency access to a motor vehicle comprises the steps of receiving a generation request at a remote vehicle management device to generate emergency access information for an emergency access to a motor vehicle, providing emergency access information to a user of the motor vehicle, providing the emergency access information by way of the user at the motor vehicle, reading the emergency access information by way of the motor vehicle, and providing an emergency access to the motor vehicle by way of the motor vehicle in response to reading the emergency access information.

The method according to forms of the invention is used in particular to enable an emergency access to a motor vehicle. An emergency access can be necessary in particular if a lawful user, such as a possessor and/or owner of the motor vehicle, has lost their original or functional access key and/or no longer has access thereto. Alternatively or additionally, an emergency access can also be necessary because the motor vehicle is in an emergency and/or an emergency situation, for example, because it has had an accident and/or because a person is confined and/or trapped therein. In this case, it is desirable for an emergency aid user, such as a representative of the rescue teams, to be able to gain access to the motor vehicle, in particular also without cooperation of a user such as a possessor and/or owner. Service provider users, such as a rental car operator or fleet operator, can likewise require an emergency access to the motor vehicle. For these purposes, an emergency access to the motor vehicle is provided, which in particular can only be available temporarily or for a short time, in particular for one-time use, and can have a restricted functional scope. In particular, the emergency access is not a full-fledged digital access key for the motor vehicle.

For this purpose, in a first step a generation request is received or detected at a remote vehicle management device in order to generate emergency access information for an emergency access to a motor vehicle.

The remote vehicle management device, which can also be referred to as a remote, in particular first computing device or vehicle computing device, is designed as different, separate, and spaced apart from the motor vehicle and a user terminal. The remote vehicle management device can comprise one or more servers here, which can also be organized partially or completely in the cloud. The remote vehicle management device can in particular be operated by a producer of the motor vehicle and, in particular exclusively, used for managing digital access keys and in particular for an emergency access for one or more motor vehicles.

The generation request originates in particular from a user who desires emergency access. For this purpose, the user can use, for example, a user terminal and/or a personal computer. A user terminal, which can also be referred to as a user device, is an apparatus or a device which is designed to receive user operating inputs, user inputs, and/or user commands and to communicate with a motor vehicle and one or more computing devices.

In particular, the user terminal is a portable or mobile device different from the motor vehicle, which can be designed in particular as a so-called smart device, thus as a device having at least one processor unit, such as a smart phone, a phablet, or a tablet, a smartwatch, smart glasses, and/or a wearable, which also provides other functions, such as telephony, surfing the Internet, or providing message services, for example, by way of applications, apps, or program.

In particular, the user terminal has at least one application which is designed and configured for managing an access, and in particular an emergency access, to at least one motor vehicle, in particular the motor vehicle. Alternatively or additionally, the user terminal has at least one browser, which is designed so it can access a website which is designed and configured for managing and access and in particular an emergency access to at least one motor vehicle, in particular the motor vehicle.

The user therefore provides their generation request, in particular by visiting a website and/or by inputs in an application, via the user terminal and/or a personal computer to the remote vehicle management device. Alternatively or additionally, the user uses a remote emergency management device in order to provide the generation request to the remote vehicle management device via this.

The remote emergency management device, like the remote vehicle management device, can be designed as different, separate, and spaced apart from the motor vehicle and the user terminal. The remote emergency management device can comprise one or more servers here, which can also be organized partially or completely in the cloud.

A remote emergency management device, which can also be referred to as a remote, in particular second, computing device or emergency computing device, can be operated in particular by a service provider of the motor vehicle, such as a fleet operator and/or rental car operator in particular. Alternatively or additionally, the remote emergency management device can be operated by one or more rescue teams, such as paramedics and/or fire departments, or one or more authorities, in particular law enforcement authorities, such as the police and/or the federal police. The remote emergency management device is used, in particular exclusively, for an emergency access for one or more motor vehicles. In particular the remote emergency management device is used when or because the access in question is by an owner or possessor, in particular a user who was originally not authorized for disposal, and this user is not registered, for example, on or for an emergency access to the motor vehicle.

A digital access key is typically used to obtain proper access to the motor vehicle using a user terminal. Such a digital access key can be based in particular on an asymmetrical cryptographic system and/or use such a system, wherein both the motor vehicle and the user terminal have a private key and a public key which are designed to authorize or legitimate one another. In particular, however, the user terminal used in the present method does not have a valid digital access key for the motor vehicle at the time of carrying out the method, in particular does not if an emergency management device is additionally used.

In response to the generation request, emergency access information for an emergency access to the motor vehicle can then be generated at the remote vehicle management device. The emergency access information is information or a datum in this case, which the motor vehicle can read and process in order to provide an emergency access, as will be explained hereinafter. The term information is used here synonymously both in the singular and in the plural and comprises both one item and multiple items of information and/or data. In particular, a combination of username and password can also be input by the user together with the generation request, which can be verified, in particular before generating the emergency access information.

The communication, in particular the mutual provision of information and/or requests, between the user, the user terminal, the personal computer, the remote vehicle management device, and/or the remote emergency management device can take place in particular via one or more wired and/or wireless communication protocols or standards, in particular long-range communication protocols, such as one or more of LAN, WLAN, and WIFI, satellite communication, in particular Iridium, Orbcomm, and/or Thuraya, and/or mobile wireless, in particular 3G, 4G, 5G, etc.

This previously generated emergency access information is then provided to the user and in particular to a user terminal and/or a personal computer. From there, the user can use the emergency access information further, in particular in digital form or also in physical form, as will be explained hereinafter. This emergency access information is then provided by the user to the motor vehicle and read there. In particular, the emergency access information and in particular the user terminal on which it is stored, or the medium on which it is embodied, is brought into the vicinity of the motor vehicle, in particular into a detection radius of a detection device of the motor vehicle in order to read it, as will also be explained hereinafter.

In response to the readout, an emergency access is provided to the motor vehicle by the motor vehicle. In particular, an emergency access is provided without further communication of the motor vehicle with the remote vehicle management device and/or the remote emergency management device after the readout at the user. An emergency access can in particular comprise enabling or providing one or more vehicle functions in this case, in particular those functions which are not possible or executable without a digital access key and/or emergency access information.

In particular the emergency access comprises, however, a reduced functional scope in relation to a full access, as is enabled using a digital access key and/or a physical key. For example, one or more functions of the motor vehicle are deactivated, blocked, and/or not activatable without a digital access key and/or a physical key. In particular, the emergency access is only provided to a limited extent, in particular for a limited number, for example, one time, in particular a single time, two times, three times, four times, or five times. Alternatively or additionally, the emergency access is only provided for a limited duration, in particular 1 min, 2 min, 5 min, 10 min, 15 min, 30 min, or 60 min. Furthermore, alternatively or additionally, the emergency access is only provided for a specific number of functions, for example one, in particular one single function, two functions, three functions, four functions, or five functions. The number, duration, and scope are directed in particular according to a preset, in particular at the remote vehicle management device, according to user input, in particular by a possessor and/or owner of the motor vehicle, and/or according to the type of user. Number and scope can also be made dependent on one or more user parameters which can be provided, for example, together with the generation request to the remote vehicle management device.

An emergency situation at a motor vehicle is enabled by the method according to the invention, in particular without a valid physical key and/or a valid digital access key being present. This is suitable in particular in an emergency situation in which a lawful user, such as a possessor or owner of the motor vehicle, is obstructed and/or is not present.

According to one refinement, the emergency access information comprises an optically machine-readable code and the reading of the emergency access information is carried out by optically capturing the machine-readable code.

The emergency access information comprises an optically machine-readable code here, which can also be referred to as a machine-readable code and/or optical code and which is captured and read by optical capture, for example, using an image capture device. The emergency access information can in particular not be readable by humans or decipherable by a human, or at least not directly.

For example, the optically machine-readable code comprises one or more characters, for example, one or more pixels, which can form a pattern of light and dark and which represent a bit sequence or a digital code. In particular, the optically machine-readable code comprises a barcode. Alternatively or additionally, the optically machine-readable code comprises a quick response (QR) code. In particular, it can be a micro-QR code, a secure QR code, and/or an iQR code.

The optically machine-readable code can be designed as solely digital or also analog, i.e. embodied on a medium, both of which will be explained hereinafter.

A particularly easy emergency access is enabled by this refinement.

According to one refinement, the method furthermore comprises the step of displaying the optically machine-readable code on a display device of a user terminal, wherein the emergency access information is read by optically capturing the displayed machine-readable code.

The emergency access information in the form of the optically machine-readable code is displayed here on a display device of the user terminal and read by optical capture of the displayed machine-readable code. For example, the optically machine-readable code was previously provided by the remote vehicle management device and/or the remote emergency management device as an image file on the user terminal. Alternatively or additionally, emergency access information was provided to the user terminal by the remote vehicle management device and/or the remote emergency management device, which enables the user terminal to generate and display an optically machine-readable code. The optically machine-readable code is then displayed on a display device, such as a display, of the user terminal and brought into the vicinity of or into a capture radius of a capture device, such as an image capture device, and read there.

A particularly easy emergency access is enabled by this refinement, which in particular does not require special technical measures or devices on the part of the user terminal and the motor vehicle.

According to one refinement, the method furthermore comprises the step of printing out the optically machine-readable code using a printer device, wherein the emergency access information is read by optically capturing the printed optically machine-readable code.

The optically machine-readable code is printed in this refinement with the aid of a printer device, such as a laser printer or inkjet printer, and therefore embodied. The optically machine-readable code can be applied here, for example, to paper, paperboard, cardboard, and/or plastic by a suitable printing method. For this purpose, the optically machine-readable code and/or emergency access information, which enable an optically machine-readable code to be generated, are provided to a suitable printer device. This can be carried out, for example, by the user terminal, the personal computer, the remote vehicle management device, and/or the remote emergency management device. The printed optically machine-readable code is then brought on a carrier material into the vicinity of or into a capture radius of a capture device, such as an image capture device, and read there.

This refinement enables a particularly simple emergency access, which in particular does not require a user terminal.

According to one refinement, the optically machine-readable code is optically captured using an image capture device comprised by the motor vehicle.

The image capture device is comprised here by the motor vehicle. In particular, it is an image capture device which is not exclusively provided for the purpose of reading the emergency access information or the optically machine-readable code, both in printed and in displayed form, but rather which also enables or provides other functions in or on the motor vehicle, for example, interior monitoring and/or exterior monitoring. In particular, the image capture device is a camera device, such as a CMOS sensor.

The image capture device can be arranged in particular in the interior, for example, a passenger interior, of the motor vehicle and can capture an area of the exterior. Alternatively or additionally, the image capture device is arranged on an exterior of the motor vehicle and likewise captures an area of the exterior. In particular, a capture area of the image capture device is configured and designed such that it can capture an exterior on or in the surroundings of at least one door, in particular a driver door, furthermore in particular a window of the driver door and/or a door handle of the driver door, and can read an optically machine-readable code presented there by the user.

A particularly easy emergency access is enabled by this refinement, which in particular does not require special technical measures or devices on the part of the user terminal and the motor vehicle.

According to one refinement, the emergency access information is read by reading a near field communication.

According to this embodiment, the emergency access information is not captured optically or visually and read, but rather via a near field communication. In particular, a near field communication device is brought into the vicinity of a further second near field communication device, in particular a capture radius thereof, and the emergency access information is thus provided.

The provision of the emergency access information by a near field communication does not represent an alternative, in particular not an exclusive alternative, to the provision by an optically machine-readable code, but rather can also be used jointly or simultaneously. In particular, initially emergency access information can be provided via a near field communication to the user terminal and then read by the motor vehicle as an optically machine-readable code. The emergency access information can also be provided simultaneously or offset in time as an optically machine-readable code and by a near field communication.

A particularly convenient emergency access is enabled by this refinement.

According to one refinement, the near field communication is read by a near field communication between a user terminal and the motor vehicle.

In particular, in this embodiment a near field communication is established between the user terminal and the motor vehicle and emergency access information is thus provided from the user terminal to the motor vehicle. In particular, a first near field communication device is comprised by the user device and a second by the motor vehicle. In particular, the second near field communication device is arranged on, in, and/or in the vicinity of a door, in particular a driver door, furthermore in particular a door handle of a door and in particular the driver door.

A particularly convenient emergency access is enabled by this refinement.

According to one refinement, the method furthermore comprises a capture input by the user at the motor vehicle, wherein the reading of the emergency access information by the motor vehicle takes place in response to the capture input.

A capture input in this case is an input and in particular on operation of the user which prompts the motor vehicle to read or optically capture the emergency access information. For this purpose, the user can perform a gesture, in particular a predetermined and/or preset gesture, which is captured and evaluated, for example, by the image capture device. Alternatively or additionally, the user can trigger a specific interaction, in particular a physical interaction, with the motor vehicle. In particular, the capture input can comprise grasping, touching, and in particular pulling and/or pushing a door handle, in particular of the driver door.

In response to this capture input, in particular exclusively in response thereto, the emergency access information is then read or optically captured.

A particularly secure emergency access is enabled by this refinement. In particular, in this way a misuse and in particular a theft of the motor vehicle is prevented. In addition, a capture which especially conforms to data protection laws is enabled.

According to one refinement, the provision of the emergency access to the motor vehicle comprises unlocking a door, disengaging a steering wheel block, and/or releasing a gear selection lever.

As described above, the emergency access in particular comprises triggering or performing a function of the motor vehicle. One of these functions triggered by the emergency access can comprise one or more of unlocking at least one door, in particular the driver door, or multiple doors, in particular all doors of the motor vehicle, disengaging a steering wheel lock and in particular enabling a steering movement of the motor vehicle, and/or releasing a gear selection lever and in particular enabling a gear selection, in particular from a parking position into a neutral position and possibly back, in particular exclusively.

In particular, further functions, in particular all other functions of the motor vehicle except for those listed here, are blocked during the emergency access or are not enabled by an emergency access, but rather require in particular a valid digital access key or physical key.

A particularly secure emergency access is enabled by this refinement. In particular, in this way only the functions of the motor vehicle necessary in an emergency situation are enabled.

According to one refinement, the provision of the emergency access to the motor vehicle does not comprise disengaging a vehicle immobilizer, starting an ignition and/or an engine, and/or active forward movement of the motor vehicle.

As described above, the emergency access can enable only a reduced number of functions, while other functions are blocked and/or are not available during the emergency access, however. One of these functions blocked during the emergency access can comprise one or more of disengaging or deactivating a vehicle immobilizer of the motor vehicle, starting an ignition and/or an engine of the motor vehicle, and/or active forward movement of the motor vehicle.

In particular, however, passive forward movement of the motor vehicle, thus not by an intrinsic motor of the motor vehicle, but rather by muscle power and/or by vehicle-external motor, for example, by a towing vehicle or a cable winch comprised thereby, is possible, in particular after enabling a gear selection into a neutral position.

A particularly secure emergency access is enabled by this refinement. In particular, in this way a misuse and in particular a theft of the motor vehicle is prevented.

According to a further aspect, a device for providing an emergency access to a motor vehicle is specified.

The device comprises means here, in order to carry out one or more embodiments of the above-described method. In particular, the device comprises one or more processor devices to carry out the above-described method. The device also comprises in particular a memory on which code is stored, in particular in a nonvolatile manner, which, when it is executed by a processor device, causes it to carry out the above-described method.

In particular, the device can comprise a user terminal, a machine-readable code, in particular a printed optically machine-readable code, one or more remote or local computing devices, in particular a remote vehicle management device and/or a remote emergency management device, or can form a system therewith in order to carry out or at least cause the above-described method. The device can also comprise one or more motor vehicles and/or a motor vehicle fleet comprising multiple motor vehicles or form a system therewith. In particular, the device can comprise every apparatus and/or every device as described above or form a system therewith.

Further features of the invention result from the claims, the figures, and the description of the figures. The features and combinations of features mentioned above in the description and the features and combinations of features mentioned hereinafter in the description of the figures and/or solely shown in the figures are usable not only in the respective specified combination, but rather also in other combinations or alone.

The invention will now be explained in more detail on the basis of a preferred exemplary embodiment and with reference to the drawings. Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic perspective view of an embodiment of a method and a device for providing an emergency access to a motor vehicle;

FIG. 2 shows a schematic flow chart of an embodiment of a method for providing an emergency access to a motor vehicle;

FIG. 3 shows a schematic flow chart of a further embodiment of a method for providing an emergency access to a motor vehicle;

FIG. 4 shows a schematic flow chart of a further embodiment of a method for providing an emergency access to a motor vehicle;

FIG. 5 shows a schematic flow chart of a further embodiment of a method for providing an emergency access to a motor vehicle; and

FIG. 6 shows a schematic flow chart of a further embodiment of a method for providing an emergency access to a motor vehicle.

### DETAILED DESCRIPTION OF THE DRAWINGS

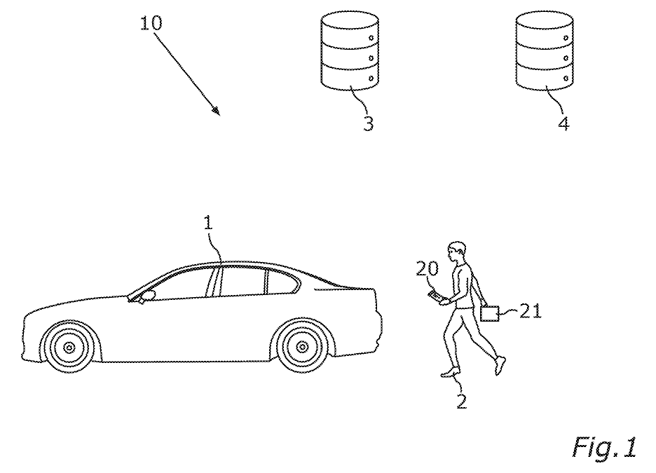

FIG. 1 shows a schematic perspective view of an embodiment of a method and a device 10 for providing an emergency access to a motor vehicle 1.

The device 10 comprises the user terminal 20 of a user 2, a remote emergency management device 3, and a remote vehicle management device 4. The device 10 is designed to carry out or at least cause the method steps described hereinafter.

The device 10 is designed to receive a generation request at the remote vehicle management device 4 in order to generate emergency access information for an emergency access to the motor vehicle 1.

The device 10 is also designed to provide the emergency access information to a user 2 of the motor vehicle 1, in particular to the user terminal 20.

The device 10 is also designed to have the emergency access information provided to the motor vehicle 1 by the user 2.

The device 10 is also designed to have the emergency access information read by the motor vehicle 1.

The device 10 is also designed to have an emergency access to the motor vehicle 1 be provided by the motor vehicle 1 in response to reading the emergency access information.

The emergency access information can comprise an optically machine-readable code here, wherein the emergency access information is read by optically capturing the machine-readable code.

The device 10 can be designed in particular to have the optically machine-readable code displayed on a display device of the user terminal 20, wherein the emergency access information is read by optically capturing the displayed machine-readable code

Alternatively or additionally, the device 10 can be designed to print the optically machine-readable code using a printer device, wherein the emergency access information is read by optically capturing the printed optically machine-readable code.

The optical capture of the optically machine-readable code can be carried out in particular using an image capture device comprised by the motor vehicle 1.

Alternatively or additionally, the emergency access information can also be read by reading a near field communication, which is carried out in particular by a near field communication between a user terminal 20 and the motor vehicle 1.

The device 10 is also designed to capture a capture input by the user 2 at the motor vehicle 1, wherein the reading of the emergency access information by the motor vehicle 1 takes place in response to the capture input.

The provision of the emergency access to the motor vehicle can in particular comprise unlocking a door of the motor vehicle 1, disengaging a steering wheel lock of the motor vehicle 1, and/or releasing a gear selection lever of the motor vehicle 1.

The provision of the emergency access to the motor vehicle in particular does not comprise disengaging a vehicle immobilizer of the motor vehicle 1, starting an ignition of the motor vehicle 1 and/or an engine of the motor vehicle 1, and/or active forward movement of the motor vehicle 1.

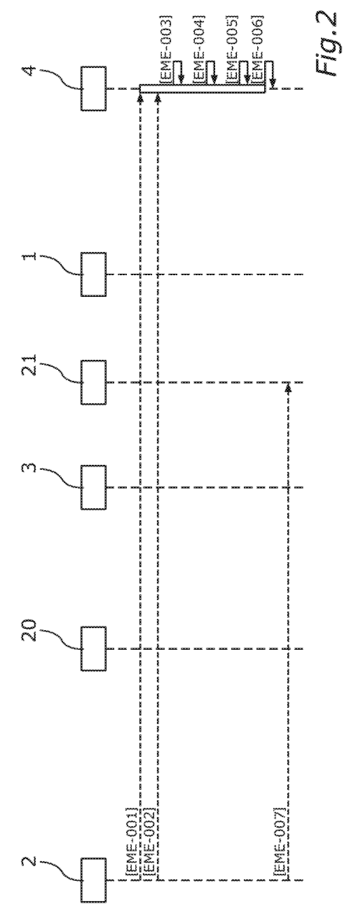

Further embodiments and embodiment details of the method described in FIG. 1 will now be explained in conjunction with following FIG. 2 to FIG. 6.

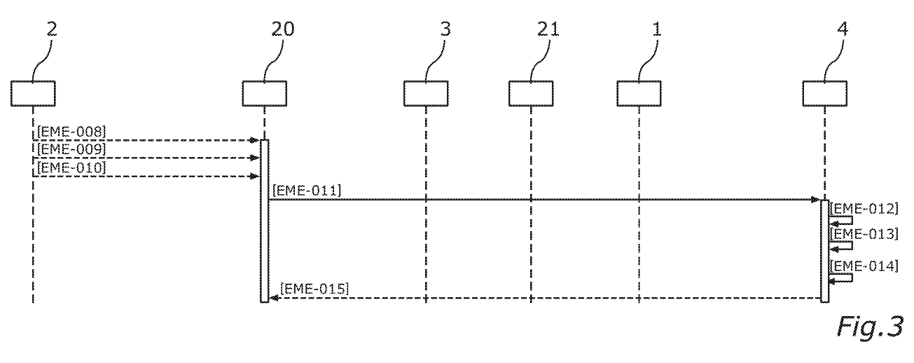

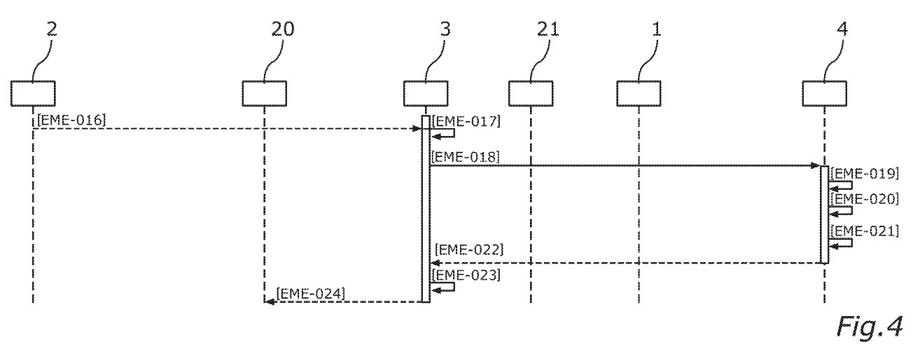

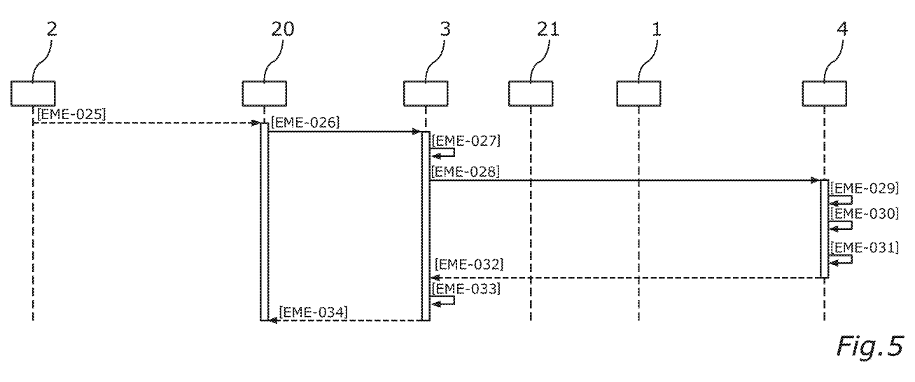

Therein, the two different embodiments shown in FIG. 2 and FIG. 3 represent generation and provision of emergency access information by a user of the motor vehicle 1, in particular a customer, possessor, and/or owner of the motor vehicle 1, the embodiment shown in FIG. 4 represents generation of emergency access information by an emergency aid user, in particular a representative of the rescue teams, such as paramedics and/or firefighters, or a representative of the authorities, in particular the law enforcement authorities, such as police and/or federal police, and the embodiment shown in FIG. 5 represents generation of emergency access information by a service provider user, in particular a representative of a motor vehicle management organization, such as a rental car operator, a fleet operator, or a motor vehicle producer. These different types of users are not distinguished by terms hereinafter and are identically designated as the user 2. These embodiments shown in FIG. 2 to FIG. 5 relate in particular to obtaining emergency access information, with the aid of which the emergency access can then be enabled or provided.

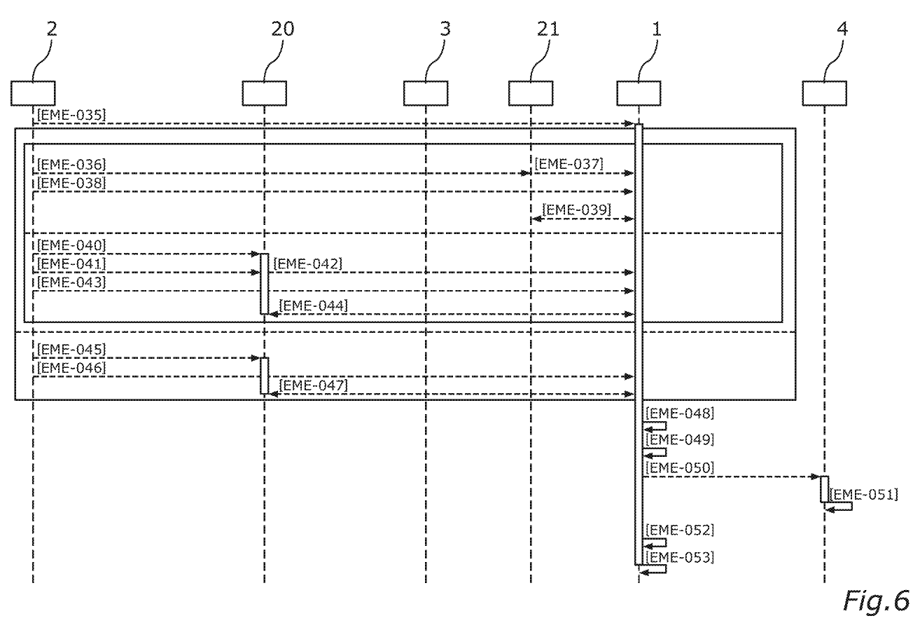

In FIG. 6, the actual emergency access to the motor vehicle 1 by the previously generated and provided emergency access information is then explained, wherein two different reading or recognition methods are distinguished here, on the one hand, reading by means of an image capture device, on the other hand, reading by means of near field communication.

It is apparent that all exemplary embodiments can exist adjacent to one another and can be implemented by a single device or a single motor vehicle. Further details are explained in detail in conjunction with the specific figure.

FIG. 2 shows a schematic flow chart of an embodiment of a method for providing an emergency access to a motor vehicle from FIG. 1.

The embodiment shown here in this FIG. 2 represents in particular generation and provision of emergency access information for an emergency access by a user 2 of the motor vehicle 1, such as a customer, possessor, and/or owner of the motor vehicle in particular. In particular, an embodiment is depicted in this FIG. 2 in which generation and provision of emergency access information is carried out by access to the remote vehicle management device 4 by the user themselves, for example, by visiting an Internet site or website, which is linked to the vehicle management device 4 or is operated thereby. Furthermore, this embodiment shown here in particular comprises printing the emergency access information onto a carrier medium, such as paper.

In a first method step EME-001 of this method section shown in FIG. 2, the user visits a website, wherein the website is configured in particular for managing an emergency access to one or more motor vehicles. This can be carried out by using a browser application, for example, on a personal computer and/or the user terminal. In particular, direct access takes place to the remote vehicle management device 4 or a website operated and/or provided thereby. The visit to the website can in particular also comprise logging in and/or, in particular for the first time, registering on the website or on the vehicle management device 4, in particular also exclusively for managing an emergency access. For this purpose, the user 2 can in particular input a combination of username and password, for which in particular an emergency access is already authorized or enabled in principle. In particular, the user 2 can also use further security features, such as a one-time password, a transaction number, and/or two-factor authentication, in order to login and/or register.

In a further method step EME-002, a generation request for generating emergency access information for an emergency access to the motor vehicle 1 is provided by the user 2 to the vehicle management device 4 and received there.

In a further method step EME-003, the validity of the visit and in particular the login and/or registration as well as the generation request are checked and in a further method step EME-004, the emergency access information, which can also be referred to as an emergency access token, is generated at the remote vehicle management device 4.

In a further method step EME-005, this generation of the emergency access information is logged at the remote vehicle management device 4 and in a further method step EME-006, the emergency access information is provided to the user 2. This provision can in particular be carried out by displaying and/or downloading the emergency access information. In particular, the emergency access information is digitally formed in this case as an image file and/or text file. The emergency access information is formed here as an optically machine-readable code, such as a quick response (QR) code, and comprises in particular one or more characters, which can be captured and evaluated by an image capture device.

In a further method step EME-007, the emergency access information is then printed as an optically machine-readable code by the user using a printer device on a carrier medium, such as paper, paperboard, and/or plastic. In an alternative method step (not shown), the digitally embodied emergency access information can be provided at the user terminal 20, for example, by an email or another message.

This emergency access information, in particular the printed optically machine-readable code 21, can then be optically captured at the motor vehicle 1, as is explained in more detail in conjunction with FIG. 6.

FIG. 3 shows a schematic flow chart of a further embodiment of a method for providing an emergency access to a motor vehicle from FIG. 1.

The embodiment shown here in FIG. 3 likewise represents in particular generation and provision of emergency access information for an emergency access by a user 2 of the motor vehicle 1, such as a customer, possessor, and/or owner of the motor vehicle in particular. In particular, in this FIG. 4, in contrast to FIG. 2, an embodiment is depicted in which generation and provision of emergency access information is carried out by access to the remote vehicle management device 4 by the user themselves, for example, by using an application or a program, which is operated in particular on the user terminal 20.

In a first method step EME-008 of this method section shown in FIG. 3, the user calls up an application on the user terminal 20, wherein the application is configured in particular for managing an emergency access to one or more motor vehicles, in particular by a communication with the remote vehicle management device 4. In particular, however, the application and/or the user terminal 20 does not have a digital access key for the motor vehicle 1 at the time of the performance of the method. The calling of the application can in particular also comprise logging in and/or, in particular the first time, registration on the application, in particular also exclusively for managing an emergency access. For this purpose, the user 2 can in particular input a combination of username and password, for which in particular an emergency access is already authorized or enabled in principle. In particular, the user 2 can also use further security features, such as a one-time password, a transaction number, and/or two-factor authentication, in order to login and/or register.

In a further method step EME-009, the user 2 calls up an emergency access function within the application of the user terminal 20, in particular in an area in the application which is concerned, in particular exclusively, with an emergency access and comprises one or more input masks for this purpose.

In a further method step EME-010, a generation request for the generation of emergency access information for an emergency access to the motor vehicle 1 is provided by the user 2 at the application of the user terminal 20 and received there.

In a further method step EME-011, in response to the generation request received at the application, this generation request is provided to the vehicle management device 4 and received there.

In a further method step EME-012, the validity of the call and in particular the login and/or registration and the generation request are checked and in a further method step EME-013, the emergency access information, which can also be referred to as an emergency access token, is generated at the remote vehicle management device 4.

In a further method step EME-014, this generation of the emergency access information is logged at the remote vehicle management device 4 and in a further method step EME-015, the emergency access information is provided to the application of the user terminal 20.

This provision can be carried out in particular by displaying and/or downloading the emergency access information. In particular, the emergency access information is also formed digitally as an image file and/or text file in this case. The emergency access information is formed here in particular as an optically machine-readable code, such as a quick response (QR) code, and comprises in particular one or more characters which can be captured and evaluated by an image capture device. This emergency access information can be stored for further use in the application. This emergency access information can then be reproduced or displayed on a display device of the user terminal 20 and optically captured at the motor vehicle 1, as is explained in more detail in conjunction with FIG. 6.

Alternatively or additionally, the emergency access information is designed such that it can be provided using near field communication by the user terminal 20 to the motor vehicle 1, as will likewise be explained in conjunction with FIG. 6.

FIG. 4 shows a schematic flow chart of a further embodiment of a method for providing an emergency access to a motor vehicle from FIG. 1.

The embodiment shown here in this FIG. 4 represents in particular generation and provision of emergency access information for an emergency access by a user 2 of the motor vehicle 1, in particular by an emergency aid user, such as a representative of the emergency services, such as paramedics and/or firefighters, or a representative of the authorities, in particular the law enforcement authorities, such as police and/or federal police. In particular, an embodiment is depicted in this FIG. 4 in which generation and provision of emergency access information is carried out by access to the remote vehicle management device 4 via a remote emergency management device 3, for example, by using an application or a program, in particular an application provided for an emergency access and in particular an emergency aid access by an emergency aid user, which is in particular also operated on a or the user terminal 20. The remote emergency management device 3 is operated and/or managed in particular by an authority and/or the emergency services.

In a first method step EME-016 of this method section shown in FIG. 4, a generation request for generation of emergency access information for an emergency access to the motor vehicle 1 is provided by the user 2 to the remote emergency management device 3 and received there.

In a further method step EME-017, the validity of the request is checked. This can likewise optionally be checked using a combination of username and password.

In a further method step EME-018, the generation request for generation of emergency access information is provided by the remote emergency management device 3 to the remote vehicle management device 4.

In a further method step EME-019, the validity of the generation request is checked by the remote emergency management device 3 at the remote vehicle management device 4 and in a further method step EME-020, the emergency access information, which can also be referred to as an emergency access token, is generated at the remote vehicle management device 4.

In a further method step EME-021, this generation of the emergency access information is logged at the remote vehicle management device 4 and in a further method step EME-022, the emergency access information is provided by the remote vehicle management device 4 to the remote emergency management device 3.

In a further method step EME-023, the provision of the emergency access information is logged at the remote emergency management device 3.

In a further method step EME-024, the emergency access information is provided at the user terminal 20. This provision can be carried out in particular by displaying and/or downloading the emergency access information. In particular, the emergency access information is also formed digitally as an image file and/or text file in this case. The emergency access information is formed in particular as an optically machine-readable code here, such as a quick response (QR) code, and in particular comprises one or more characters which can be captured and evaluated by an image capture device. This emergency access information can then be stored for further use in the application. This emergency access information can then be reproduced or displayed on a display device of the user terminal 20 and optically captured at the motor vehicle 1, as will be explained in more detail in conjunction with FIG. 6.

Alternatively or additionally, the emergency access information is formed such that it can be provided by the user terminal 20 to the motor vehicle 1 using a near field communication, as will likewise be explained in conjunction with FIG. 6.

FIG. 5 shows a schematic flow chart of a further embodiment of a method for providing an emergency access to a motor vehicle from FIG. 1.

The embodiment shown here in this FIG. 5 represents in particular generation and provision of emergency access information for an emergency access by a user 2 of the motor vehicle 1, in particular a service provider user, such as a representative of a motor vehicle management organization, such as a rental car operator, a fleet operator, or a motor vehicle producer. In particular, an embodiment is depicted in this FIG. 5 in which generation and provision of emergency access information is carried out by access to the remote vehicle management device 4 via a remote emergency management device 3, for example, by using an application or a program, in particular an application provided for an emergency access by a service provider user, which is also operated in particular on a or the user terminal 20. The remote emergency management device 3 is operated and/or managed here in particular by a motor vehicle management organization.

In a first method step EME-025 of this method section shown in FIG. 5, a generation request for generation of emergency access information for an emergency access to the motor vehicle 1 is provided by the user 2 at an application of the user terminal 20 and received there.

In a further method step EME-026, this generation request for generation of emergency access information is provided by the user terminal 20 to the remote emergency management device 3.

In a further method step EME-027, the validity of the request is checked at the remote emergency management device 3. This can likewise optionally be checked using a combination of username and password.

In a further method step EME-028, the generation request for generation of emergency access information is provided by the remote emergency management device 3 to the remote vehicle management device 4.

In a further method step EME-029, the validity of the generation request by the remote emergency management device 3 is checked at the remote vehicle management device 4 and in a further method step EME-030, the emergency access information, which can also be referred to as an emergency access token, is generated at the remote vehicle management device 4.

In a further method step EME-031, this generation of the emergency access information is logged at the remote vehicle management device 4 and in a further method step EME-032, the emergency access information is provided by the remote vehicle management device 4 to the remote emergency management device 3.

In a further method step EME-033, the provision of the emergency access information is logged at the remote emergency management device 3.

In a further method step EME-034, the emergency access information is provided at the user terminal 20. This provision can be carried out in particular by displaying and/or downloading the emergency access information. In particular, the emergency access information is also formed digitally as an image file and/or text file in this case. The emergency access information is formed in particular as an optically machine-readable code, such as a quick response (QR) code, and comprises in particular one or more characters which can be captured and evaluated by an image capture device. This emergency access information can then be stored for further use in the application. This emergency access information can then be reproduced or displayed on a display device of the user terminal 20 and optically captured at the motor vehicle 1, as will be explained in more detail in conjunction with FIG. 6.

Alternatively or additionally, the emergency access information is formed such that it can be provided by the user terminal 20 to the motor vehicle 1 using a near field communication, as will likewise be explained in conjunction with FIG. 6.

FIG. 6 shows a schematic flow chart of a further embodiment of a method for providing an emergency access to a motor vehicle from FIG. 1.

In this FIG. 6 the actual emergency access to the motor vehicle 1 by the emergency access information previously generated and provided in FIG. 2, FIG. 3, FIG. 4, and/or FIG. 5 is explained, wherein a distinction is made here in particular into two different reading or recognition methods. On the one hand, on optically machine-readable code is read by means of an image capture device, as described in steps EME-036 to EME-044. These steps are to be distinguished once again, on the one hand into an embodiment in which the optically machine-readable code was printed using a printer device, as described in steps EME-036 to EME-039, and on the other hand into an embodiment in which the optically machine-readable code is displayed on a display device of the user terminal 20, as described in steps EME-040 to EME-044. On the other hand, reading is carried out by means of a near field communication, as described in steps EME-045 to 047. Steps EME-045 to 053 then describe the access independently of the selected type of reading and form of provision.

In particular, an embodiment as shown in FIG. 2, FIG. 3, FIG. 4, and/or FIG. 5 was previously run through at least once and emergency access information was generated and/or provided at least once previously.

In a first method step EME-035 of this method section shown in FIG. 6, the user 2 approaches the motor vehicle 1, in particular in a capture radius of an image capture device comprised by the motor vehicle and/or in a capture radius of a near field communication device comprised by the motor vehicle. It is unimportant here whether the user 2 is a customer, possessor, and/or owner of the motor vehicle 1, an emergency aid user, or a service provider user, and the statements described hereinafter apply to all embodiments explained in conjunction with FIG. 2 to FIG. 5.

In a further method step EME-036, the emergency access information is provided as a printed optically machine-readable code 21 by the user 2 and in a further method step EME-037, this printed optically machine-readable code 21 is provided by the user 2 at the motor vehicle 1, in particular at an image capture device of the motor vehicle 1 and/or in a capture radius thereof.

In a further method step EME-038, a capture input is provided by the user 2 at the motor vehicle 1. This can take place in particular in the form of operating a doorhandle, in particular a doorhandle of a driver door, for example, by grasping, touching, and in particular pulling and/or pushing the doorhandle. This capture input in particular triggers a capture of an image capture device comprised by the motor vehicle 1.

In a further method step EME-039, in response to this capture input, the printed optically machine-readable code is read by an image capture device of the motor vehicle 1 from the printout located in a capture radius of the image capture device by optical capture.

In an alternative further method step EME-040, an application and/or a website for an emergency access is opened on the user terminal 20 by the user 2, and in a further method step EME-041, a user input is provided or received by the user 2 at the application of the user terminal 20 in order to provide the emergency access information as an optically machine-readable code in the form of a displayed image, which is carried out in a further method step EME-042 by the application of the user terminal 20.

In a further method step EME-043, a capture input is provided by the user 2 at the motor vehicle 1. This can take place in particular in the form of operating a doorhandle, in particular a doorhandle of a driver door, for example, by grasping, touching, and in particular pulling and/or pushing the doorhandle. This capture input in particular triggers a capture of an image capture device comprised by the motor vehicle 1.

In a further method step EME-044, in response to this capture input, the optically machine-readable code displayed on the user terminal 20 is read by an image capture device of the motor vehicle 1 from the user terminal 20 located in a capture radius of the image capture device by optical capture.

In a likewise alternative further method step EME-045, an application and/or website for an emergency access is opened on the user terminal 20 by the user 2, and in a further method step EME-046, the user terminal 20 is introduced by the user 2 into a capture radius of a near field communication device of the motor vehicle 1 or provided thereon in order to read the emergency access information via a near field communication between the user terminal 20 and the motor vehicle 1, which takes place in a further step EME-047. In particular, in this alternative a capture input by the user 2 is not necessary or is obsolete and does not take place.

Independently of the above-described three embodiments for reading the emergency access information, in a further method step EME-048, this emergency access information is then verified at the motor vehicle 1 and in a further method step EME-049, this emergency access is logged at the motor vehicle 1.

In a further method step EME-050, this emergency access is provided by the motor vehicle 1 to the remote vehicle management device 4, and in a further method step EME-051, this emergency access is persisted there at the remote vehicle management device 4.

In a further method step EME-052, an emergency access mode is activated or configured at the motor vehicle 1. In particular, in this step the functions or the functional scope are defined or authorized. This functional scope can differ in particular according to the type of the user. For example, a higher functional scope can be authorized for a user 2 who is a customer, possessor, and/or owner of the motor vehicle 1 than for an emergency aid user or a service provider user. For example, a gear change, in particular from a parking position to a neutral position, can be authorized as a function or not.

In a further and last method step EME-053, at least one door of the motor vehicle 1 is unlocked.

In particular, this at least one unlocked door can then be locked again after a predetermined time and in particular after being closed once.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of reference signs

1 motor vehicle

2 user

3 remote emergency management device

4 remote vehicle management device

20 user terminal

21 printed optically machine-readable code

EME-001 method step

EME-002 method step

EME-003 method step

EME-004 method step

EME-005 method step

EME-006 method step

EME-007 method step

EME-008 method step

EME-009 method step

EME-010 method step

EME-011 method step

EME-012 method step

EME-013 method step

EME-014 method step

EME-015 method step

EME-016 method step

EME-017 method step

EME-018 method step

EME-019 method step

EME-020 method step

EME-021 method step

EME-022 method step

EME-023 method step

EME-024 method step

EME-025 method step

EME-026 method step

EME-027 method step

EME-028 method step

EME-029 method step

EME-030 method step

EME-031 method step

EME-032 method step

EME-033 method step

EME-034 method step

EME-035 method step

EME-036 method step

EME-037 method step

EME-038 method step

EME-039 method step

EME-040 method step

EME-041 method step

EME-042 method step

EME-043 method step

EME-044 method step

EME-045 method step

EME-046 method step

EME-047 method step

EME-048 method step

EME-049 method step

EME-050 method step

EME-051 method step

EME-052 method step

EME-053 method step

What is claimed is:

1. A method for providing emergency access to a motor vehicle, comprising:
receiving a generation request at a remote vehicle management device to generate emergency access information for emergency access to a motor vehicle;
providing emergency access information to a user of the motor vehicle;
receiving the emergency access information at the motor vehicle from the user;
reading the emergency access information by way of the motor vehicle; and
providing the emergency access to the motor vehicle by way of the motor vehicle in response to reading the emergency access information.

2. The method according to claim 1, wherein:
the emergency access information comprises an optically machine-readable code; and
the emergency access information is read by optically capturing the optically machine-readable code.

3. The method according to claim 2, further comprising:
displaying the optically machine-readable code on a display device of a user terminal;
wherein the emergency access information is read by optically capturing the displayed optically machine-readable code.

4. The method according to claim 2, further comprising:
printing the optically machine-readable code using a printer device;
wherein the emergency access information is read by optically capturing the printed optically machine-readable code.

5. The method according to claim 2, wherein the optically machine-readable code is optically captured using an image capture device of the motor vehicle.

6. The method according to claim 1, wherein the emergency access information is read by reading a near field communication.

7. The method according to claim 6, wherein the near field communication is read by a near field communication between a user terminal and the motor vehicle.

8. The method according to claim 1, further comprising:
capturing an input at the motor vehicle by the user;
wherein the reading of the emergency access information by the motor vehicle takes place in response to the capturing of the input.

9. The method according to claim 1, wherein providing the emergency access to the motor vehicle comprises at least one of unlocking a door of the motor vehicle, disengaging a steering wheel lock of the motor vehicle, or releasing a gear selection lever of the motor vehicle.

10. The method according to claim 1, wherein providing the emergency access to the motor vehicle does not comprise at least one of disengaging a vehicle immobilizer of the motor vehicle, starting at least one of an ignition or an engine of the motor vehicle, or active forward movement of the motor vehicle.

11. A device for providing emergency access to a motor vehicle, wherein the device comprises means to perform the method of claim 1
